(19) United States
(12) Patent Application Publication
(10) Pub. No.: US 2002/0048999 A1
(43) Pub. Date: Apr. 25, 2002

(54) Electrical connector

(76) Inventor: Tung Ming-Hui, Taipei Hsien (TW)

Correspondence Address: Stephen Z. Weiss, MOLEX INCORPORATED, 2222 Wellington Court, Lisle, IL, 60532, US

(21) Appl. No.: 09/920,417

(22) Filed: Aug. 1, 2001

(30) Foreign Application Priority Data
Sep. 1, 2000 (TW) 89215201

(51) Int. Cl. H01R 24/00

(52) U.S. Cl. 439/660

(57) ABSTRACT

An electrical connector includes a dielectric housing having a top mating face and a front terminal-insertion face. At least one terminal-receiving chamber is formed in the housing with a top opening communicating with the top mating face, and a front opening communicating with the front face. The chamber includes a pair of opposite interior side walls, with a pair of guide channels in the side walls communicating with the front opening. A terminal is inserted into the chamber through the front opening in the housing. The terminal includes a contact portion exposed through the top opening for engaging an appropriate contact of a complementary mating connecting device. The terminal has a pair of wing portions for sliding in the guide channels with an interference fit to retain the terminal in the chamber.

### FIELD OF THE INVENTION

This invention generally relates to the art of electrical connectors and, particularly, a system for retaining terminals within a dielectric housing of an electrical connector.

### BACKGROUND OF THE INVENTION

Generally, an electrical connector includes some form of insulating or dielectric housing which mounts a plurality of conductive terminals. The terminals typically have contact portions for engaging the contact means of some type of mating connecting device, along with terminating portions for termination to appropriate conductors which may range from discrete electrical wires to the circuit means on a printed circuit board.

The terminals of such electrical connectors are secured within the dielectric housing by various retaining means which may range from mechanical latches to completely overmolding the dielectric housing about portions of the terminals. One type of retaining means is provided by forming the terminals with sharp teeth whereby the terminals can be inserted into terminal-receiving cavities or chambers in the housing, with the teeth biting into the plastic material of the housing to retain the terminals therein.

For instance, FIGS. 1 and 2 show a prior art electrical connector, generally designated 10, which includes a dielectric housing, generally designated 12, mounting a plurality of conductive terminals, generally designated 14. The housing may be molded of plastic material, and the terminals may be stamped and formed from conductive sheet metal material. Housing 12 includes a plurality of terminal-receiving cavities or chambers, generally designated 16, defined by opposing side walls 18. The chambers have front openings 20 in a front face 22 of the housing and through which the terminals are inserted into the chambers in the direction of arrows “A” (FIG. 1). The chambers are open at a top face or wall 24 of the housing, with the top face slightly overlapping the chambers to form lips 26 along the top side edges thereof. In other words, the lips overhang the chambers. Connector 10 shown in FIG. 1 is a conventional battery connector whereby mating face 24 of housing 12 is placed into mating abutment with an appropriate apparatus containing a battery.

Referring to FIG. 2 in conjunction with FIG. 1, each terminal 14 of prior art connector 10 is generally U-shaped to define a contact arm 28 and a base 30 joined by a bent spring portion 32. The terminal may be stamped and formed of conductive sheet metal material. Contact arm 28 is bowed upwardly to form a convex contact portion 34 which projects upwardly from a respective one of the terminal-receiving chambers 16 above mating face 24 of connector housing 12 as seen in FIG. 1. A pair of ears 36 project outwardly from opposite sides of contact arm 28 for engagement beneath lips 26 of the housing to limit the degree to which contact portion 34 can project above the housing.

Still referring to FIG. 2, base 30 of U-shaped terminal 14 has a distal end 30a which defines a solder tail for connecting the terminal, as by soldering, to circuit means on an appropriate printed circuit board. Base 30 has a retaining section 30b with a plurality of sharp teeth 38 projecting from opposite sides thereof. When terminals 14 are inserted into chambers 16 of housing 12 in the direction of arrows “A” (FIG. 1), sharp teeth 38 bite or dig into the plastic material of the housing along side walls 18 of the chambers to retain the terminals in the chambers.

Retention systems of the character described above in relation to prior art connector 10 using sharp retaining teeth 38 have various disadvantages. For instance, the pointed contact between teeth 38 and side walls 18 of the chambers may result in uneven force applications at opposite sides of the terminal which could vary the advancing direction of a given terminal. This may cause the terminal to become skewed within its chamber. In addition, the interference fit between the points of the teeth and the side walls of the chambers does not provide a significant positioning force. If the terminals are subjected to significant external forces, they most likely will start to vibrate and even become disengaged which may affect solder tails 30a or change the positions of contact portions 34, thereby resulting in poor contact engagements. Still further, it is extremely difficult if at all possible to stamp and form teeth 38 to precise dimensions. The extent that the teeth project from base 30 at opposite sides thereof could vary significantly. Again, this would result in uneven application of forces at opposite sides of the terminal as well as resulting in insufficient guiding of the terminal into the chamber. The skiving of the teeth into the plastic material, itself, does not provide very accurate positioning of the terminal within its respective chamber.

The present invention is directed to solving the various problems identified above and satisfying a need for a simple retention system for the terminals in electrical connectors as described above.

### SUMMARY OF THE INVENTION

An object, therefore, of the invention is to provide an electrical connector with an improved arrangement for retaining the terminals of the connector in a dielectric housing of the connector.

In the exemplary embodiment of the invention, the connector includes a dielectric housing having a bottom circuit board-mounting face, a top mating face and a front terminal-insertion face. At least one terminal-receiving chamber has a bottom opening communicating with the bottom face of the housing, a top opening communicating with the top mating face and a front opening communicating with the front face. The chamber further has a pair of opposite interior side walls, along with a pair of guide channels in the interior side walls communicating with the front opening of the chamber.

A terminal is inserted into the chamber through the front opening in the front terminal-insertion face of the housing. The terminal includes a contact portion exposed through the top opening for engaging appropriate contact means of a complementary mating connecting device. A terminal portion extends through the bottom opening for engaging appropriate circuit means on a printed circuit board. A pair of wing portions slidably engage within the guide channels with an interference fit to retain the terminal in the chamber.

As disclosed herein, the top opening of the chamber extends into the front opening thereof at the front terminal-insertion face of the housing. The contact portion of the terminal comprises a spring contact arm extending through the top opening. Complementary interengaging stop surfaces are provided between the spring contact arm and the housing to limit the amount the spring contact arm can extend through the top opening.

According to an aspect of the invention, the terminal includes a base with the wing portions being defined by opposite edges of the base. The terminal is generally U-shaped to define two legs formed by a spring bight portion. One leg forms the base and the other leg forms the contact portion of the terminal. The terminating portion of the terminal is formed from the base.

Other features of the invention include providing the guide channels with flared mouths to facilitate guiding the wing portions into the channels. The wing portions have offset retention sections for establishing an interference fit within the guide channels.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of an electrical connector according to the prior art;

FIG. 2 is a perspective view of one of the terminals of the prior art connector of FIG. 1;

FIG. 3 is a perspective view of an electrical connector according to the invention;

FIG. 4 is a perspective view of the dielectric housing of the connector of FIG. 3, in conjunction with one of the terminals about to be inserted into the housing; and

FIG. 5 is a perspective section taken generally along line 5-5 of FIG. 3.

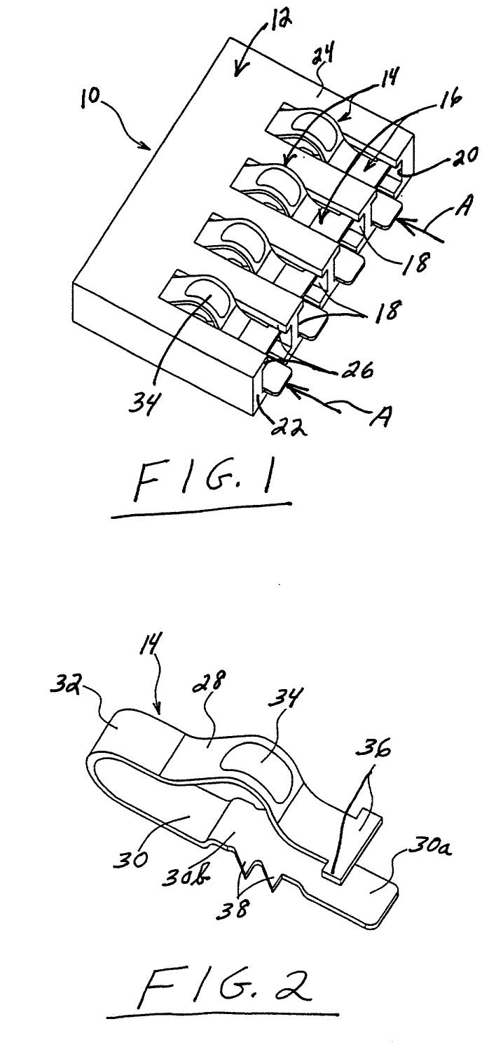

### DETAILED DESCRIPTION OF THE PREFERRED EMBODIMENT

Referring to the drawings in greater detail, and first to FIG. 3, the invention is embodied in an electrical connector, generally designated 40, which includes a dielectric housing, generally designated 42, which mounts a plurality of conductive terminals, generally designated 44. Housing 42 preferably is molded of plastic material, and terminals 44 are stamped and formed from conductive sheet metal material.

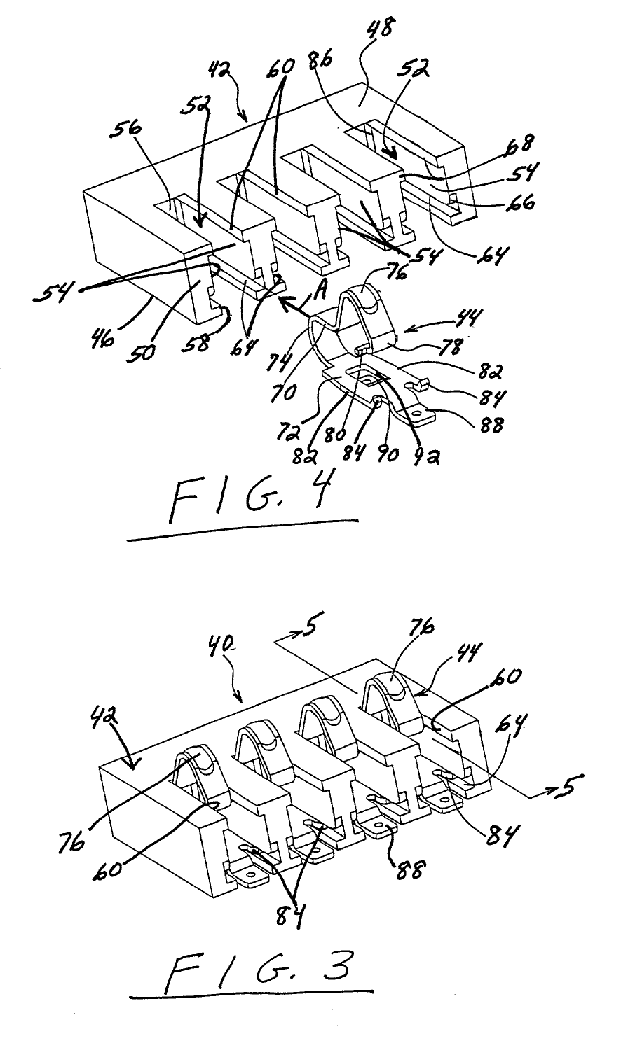

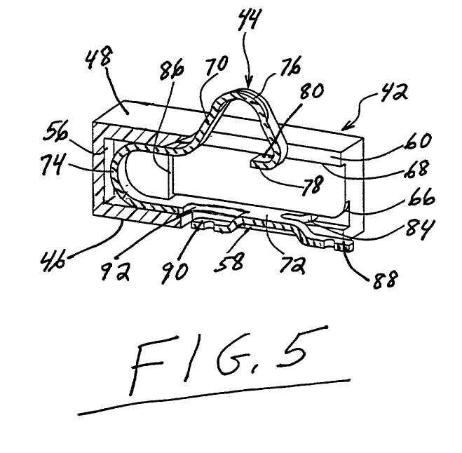

Referring to FIG. 4 in conjunction with FIG. 3, dielectric housing 42 includes a bottom face 46 for mounting on a printed circuit board (not shown), a top mating face 48 and a front terminal-insertion face 50. Connector 40 is designed as a battery connector, and top mating face 48 is oriented for interfacing with a complementary mating connecting device (not shown) which may be a battery-containing component.

Still referring to FIG. 4, housing 42 includes a plurality of terminal-receiving chambers, generally designated 52, which include opposite interior side walls 54 leading inwardly toward a rear wall 56. Each chamber includes a bottom opening 58 communicating with bottom circuit board-mounting face 46, a top opening 60 communicating with top mating face 48 and a front opening 62 communicating with front terminal-insertion face 50. A pair of guide channels 64 are formed in opposing interior side walls 54 adjacent bottom opening 58 of each channel. The mouths of the channels are rounded or flared, as at 66, at the tops thereof. Finally, overhanging lips 68 are formed along top openings 60 of the channels.

Referring to FIG. 5 in conjunction with FIGS. 3 and 4, terminals 44 are inserted into chambers 52 in the direction of arrow “A” (FIG. 4) until the terminals are fully seated within the chambers as shown in FIGS. 3 and 5. Each terminal 44 is generally U-shaped to define a pair of legs 70 and 72 joined by a curved bight portion 74. Leg 70 defines a spring contact arm of the terminal and leg 72 forms a base of the terminal, while bight portion 74 joins the contact arm to the base and provides resiliency or spring action to the contact arm. Spring contact arm 70 is bowed upwardly to define a contact portion 76 which projects upwardly through top opening 60 of a respective one of the terminal-receiving chambers 52. Therefore, the contact portion is resiliently engageable with contact means of the complementary mating connecting device. A distal end 78 of the spring contact arm is bent back rearwardly, and a pair of ears 80 project laterally outwardly from the distal end for engagement beneath lips 68 at the top of the respective chamber to limit the amount that contact portion 76 can project upwardly of the connecting housing.

In order to guide terminals 44 into chambers 52 of housing 42, base 72 is wider than bight portion 74 and spring contact arm 70 of the terminal to define a pair of wing portions 82 along opposite edges of the base. Base 72, along with wing portions 82, is generally planar, and the wing portions are provided with upwardly turned or offset retention tabs or sections 84 at the front edges of the wing portions. When terminals 44 are inserted into chambers 52 in the direction of arrow “A” (FIG. 4), wing portions 82 at the opposite edges of base 72 slide into channels 64 in opposite side walls 54 of the chambers. The channels guide the terminals into the chambers. When the terminals are substantially inserted, offset retention sections or tabs 84 engage within the guide channels with an interference fit. In other words, tabs 84 are offset or turned upwardly from base 72 and wing portions 82 a distance for establishing an interference fit within the guide channels to retain the terminals in chambers 52. Flared mouths 54 at the front of guide channels 64 facilitate guiding wing portions 82 into the channels. Therefore, the terminals are very easily inserted into the channels of dielectric housing 42, while offset retention sections 84 solidly retain the terminals in the chambers. When the terminals are fully inserted into the chambers, front edges of wing portions 82 abut against stop shoulders 86 at opposite sides of the chambers.

Finally, as stated above, connector 40 is adapted for mounting on a printed circuit board. To that end, a pair of solder tails 88 and 90 are formed out of base 72 of each terminal 44. Solder tail 88 projects forwardly of the base, and solder tail 90 is stamped and formed out of an opening 92 in the base. The solder tails are bent downwardly so that they project through bottom opening 58 as seen best in FIG. 5 so that the solder tails are generally flush with bottom face 46 of the housing for connection, as by soldering, to appropriate circuit means on the printed circuit board (not shown).

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. An electrical connector, comprising:
a dielectric housing having a bottom circuit board-mounting face, a top mating face and a front terminal-insertion face, and at least one terminal-receiving chamber having a bottom opening communicating with said bottom circuit-mounting face, a top opening communicating with said top mating face, a front opening communicating with said front terminal-insertion face, a pair of opposite interior side walls, and a pair of guide channels in said interior side walls communicating with said front opening; and
a terminal inserted into said chamber through the front opening in the front terminal-insertion face of the housing, the terminal including a contact portion exposed through said top opening for engaging appropriate contact means of a complementary mating connecting device, a terminating portion extending through said bottom opening for engaging appropriate circuit means on a printed circuit board, and a pair of wing portions for sliding in said guide channels with an interference fit to retain the terminal in the chamber.

2. The electrical connector of claim 1 wherein said top opening extends into the front opening in the front terminal-insertion face of the housing, and said contact portion of the terminal comprises a spring contact arm extending through the top opening.

3. The electrical connector of claim 2, including complementary interengaging stop surfaces between the spring contact arm and the housing to limit the amount the spring contact arm can extend through said top opening.

4. The electrical connector of claim 1 wherein said guide channels have flared mouths to facilitate guiding said wing portions into the channels.

5. The electrical connector of claim 1 wherein said terminal includes a base with said wing portions being defined by opposite edges of the base.

6. The electrical connector of claim 5 wherein said terminal is generally U-shaped to define two legs joined by a spring bight portion, one leg forming said base and the other leg forming said contact portion.

7. The electrical connector of claim 5 wherein said terminating portion is formed from the base.

8. The electrical connector of claim 1 wherein said wing portions include offset retention sections for establishing an interference fit within the guide channels.

9. The electrical connector of claim 8 wherein said offset retention sections are located near trailing ends of the wing portions as the terminal is inserted into the chamber.

10. An electrical connector, comprising:
a dielectric housing having a bottom circuit board-mounting face, a top mating face and a front terminal-insertion face, and at least one terminal-receiving chamber having a bottom opening communicating with said bottom circuit-mounting face, a front opening communicating with said front terminal-insertion face, a top opening communicating with said top mating face and extending into the front opening, a pair of opposite interior side walls, and a pair of guide channels in said interior side walls communicating with said front opening; and
a terminal inserted into said chamber through the front opening in the front terminal-insertion face of the housing, the terminal including a spring contact arm having a contact portion extending through said top opening for engaging appropriate contact means of a complementary mating connecting device, a generally planar base having wing portions at opposite edges thereof for sliding in said guide channels, the wing portions having offset retention sections for establishing an interference fit within the guide channels, and a terminating portion extending from the base through said bottom opening for engaging appropriate circuit means on a printed circuit board.

11. The electrical connector of claim 10, including complementary interengaging stop surfaces between the spring contact arm and the housing to limit the amount the spring contact arm can extend through said top opening.

12. The electrical connector of claim 10 wherein said guide channels have flared mouths to facilitate guiding said wing portions into the channels.

13. The electrical connector of claim 10 wherein said terminal is generally U-shaped to define two legs joined by a spring bight portion, one leg forming said base and the other leg forming said spring contact arm.

14. The electrical connector of claim 10 wherein said offset retention sections are located near trailing ends of the wing portions as the terminal is inserted into the chamber.

15. An electrical connector, comprising:
a dielectric housing having a top mating face and a front terminal-insertion face, at least one terminal-receiving chamber having a top opening communicating with said top mating face and a front opening communicating with said front terminal-insertion face, the chamber having a pair of opposite interior side walls, and a pair of guide channels in the side walls communicating with said front opening; and
a terminal inserted into said chamber through the front opening in the front terminal-insertion face of the housing, the terminal including a contact portion exposed through said top opening for engaging appropriate contact means of a complementary mating connecting device, and a pair of wing portions for sliding in said guide channels with an interference fit to retain the terminal in the chamber.

16. The electrical connector of claim 15 wherein said top opening extends into the front opening in the front terminal-insertion face of the housing, and said contact portion of the terminal comprises a spring contact arm extending through the top opening.

17. The electrical connector of claim 16, including complementary interengaging stop surfaces between the spring contact arm and the housing to limit the amount the spring contact arm can extend through said top opening.

18. The electrical connector of claim 15 wherein said guide channels have flared mouths to facilitate guiding said wing portions into the channels.

19. The electrical connector of claim 15 wherein said terminal includes a base with said wing portions being defined by opposite edges of the base.

20. The electrical connector of claim 19 wherein said terminal is generally U-shaped to define two legs joined by a spring bight portion, one leg forming said base and the other leg forming said contact portion.

21. The electrical connector of claim 15 wherein said wing portions include offset retention sections for establishing an interference fit within the guide channels.

22. The electrical connector of claim 21 wherein said offset retention sections are located near trailing ends of the wing portions as the terminal is inserted into the chamber.
